(19) United States
(12) Patent Application Publication
(10) Pub. No.: US 2026/0353492 A1
(43) Pub. Date: Nov. 5, 2026

(54) SYSTEMS AND METHODS FOR PERFORMING REDUNDANT SIDELINK COMMUNICATION

(71) Applicant: ZTE CORPORATION, Shenzhen (CN)

(72) Inventors: Wei LUO, Shenzhen (CN); Lin CHEN, Shenzhen (CN); Weiqiang DU, Shenzhen (CN)

(73) Assignee: ZTE CORPORATION, Shenzhen (CN)

(21) Appl. No.: 19/733,103

(22) Filed: Jul. 7, 2026

Related U.S. Application Data
(63) Continuation of application No. PCT/CN2024/071066, filed on Jan. 8, 2024.

(51) Int. Cl. H04W 76/15; H04W 72/25

(52) U.S. Cl. CPC H04W 76/15; H04W 72/25

(57) ABSTRACT

Presented are systems and methods for performing redundant sidelink communication. A first wireless communication device can receive high reliability-related information from a wireless communication node. The wireless communication node can send the high reliability-related information to the first wireless communication device. The first wireless communication device can send the high reliability-related information to the second wireless communication device. The second wireless communication device can receive the high reliability-related information from the first wireless communication device.

### CROSS-REFERENCE TO RELATED APPLICATION

This application claims the benefit of priority under 35 U.S.C. § 120 as a continuation of International Patent Application No. PCT/CN2024/071066, filed on Jan. 8, 2024, the disclosure of which is incorporated herein by reference in its entirety.

### TECHNICAL FIELD

The disclosure relates generally to wireless communications, including but not limited to systems and methods for performing redundant sidelink communication.

### BACKGROUND

Coverage is a key consideration in cellular network deployments. With the rise of interconnected devices, there is a growing focus on effective device communication. The current 3GPP standards, spanning from 3G to 5G and beyond, focus on the importance of seamless communication among various devices, from smart home devices to wearable devices. In industrial settings, the complexity of tasks often requires collaboration. This calls for several cooperative operational management systems, with the aim of creating workgroups and managing different types of devices to complete the required tasks.

### SUMMARY

The example embodiments disclosed herein are directed to solving the issues relating to one or multiple of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first wireless communication device (e.g., user equipment) can receive/obtain/acquire high reliability-related information from a wireless communication node (e.g., base station). In certain implementations, the high reliability-related information may include at least one of the following: information indicating multi-path communication is configured for the first wireless communication device; sidelink bearer configuration information; muti-path configuration information; or sidelink carrier configuration information. In certain implementations, the high reliability-related information can be sent to the first wireless communication device over a first Radio Resource Control (RRC) message.

In certain implementations, each sidelink bearer of the sidelink bearer configuration information can be associated with at least one of a Uu Radio Link Control (RLC) Channel or a sidelink RLC Channel. In certain implementations, each sidelink bearer of the sidelink bearer configuration information can be associated with multiple carriers. In certain implementations, the Uu RLC Channel can correspond to a first logical channel between the first wireless communication device and the wireless communication node. In certain implementations, the sidelink RLC channel can correspond to a second logical channel between the first wireless communication device and a second wireless communication device. In some implementations, the first and second wireless communication devices can communicate with each other through a PC5 interface.

In certain implementations, each sidelink bearer of the sidelink bearer configuration information may include a first Packet Data Convergence Protocol (PDCP) configuration indication. In some implementations, the first PDCP configuration indication can indicate a primary path as a Uu path or a sidelink path. In certain implementations, each sidelink bearer of the sidelink bearer configuration information may include a second PDCP configuration indication. In some implementations, the second PDCP configuration indication can indicate whether PDCP duplication can be activated in response to satisfying at least one of the following conditions: the first wireless communication device is in a survival state for a sidelink bearer; the first wireless communication device receives a NACK message or no feedback message for a transport block that includes the associated sidelink bearer from the second wireless communication device; the first wireless communication device receives N NACK messages or no feedback message for a transport block that includes the associated sidelink bearer from the second wireless communication device, where N is provided by the wireless communication node; the first wireless communication device receives a NACK message or no feedback message for a transport block that includes at least one sidelink bearer configured with the second PDCP configuration indication from the second wireless communication device; the first wireless communication device receives N NACK messages or no feedback message for a transport block that includes at least one sidelink bearer configured with the second PDCP configuration indication from the second wireless communication device, where N is provided by the wireless communication node; or a Channel Busy Ratio (CBR) of a current resource pool or carrier is larger than a configured threshold C1, where C1 is provided by the wireless communication node.

In certain implementations, the muti-path configuration information may include at least one of the following: a bearer ID list configuring multiple paths to transmit; a first ID or index of the first wireless communication device for a Uu path associated to the communication between the first wireless communication device and a second wireless communication device; a second ID or index of the second wireless communication device for the Uu path associated to the communication between the first wireless communication device and the second wireless communication device; a third ID or index of the first wireless communication device for a PC5 path between the first wireless communication device and the second wireless communication device; a fourth ID or index of the second wireless communication device for the PC5 path between the first wireless communication device and the second wireless communication device; a pair of a source ID and a destination ID that can be used to identify communication between the first wireless communication device and the second wireless communication device; or an indication of whether the termination point is the UE or the network.

In certain implementations, the muti-path configuration may include at least one of the following: whether L2 muti-path sidelink communication is configured; whether L3 muti-path sidelink communication is configured; whether NAS muti-path sidelink communication is configured; a source or destination ID list indicating which L3 multi-path is allowed; a source or destination ID list indicating which NAS multi-path is allowed; a source or destination ID list indicating which L2 multi-path is allowed; a pair of source and destination ID list indicating which L2 multi-path is allowed; a pair of source and destination ID list indicating which L3 multi-path is allowed; a pair of source and destination ID list indicating which NAS multi-path is allowed; an indication of a primary path; or a condition of using a secondary path.

In certain implementations, the sidelink carrier configuration information can indicate a primary carrier or a secondary carrier. In certain implementations, in response to receiving the sidelink carrier configuration information indicating the primary carrier or the secondary carrier, the first wireless communication device can transmit dedicated traffic using the primary carrier. In some implementations, in response to the condition being satisfied, the first wireless communication device can transmit the dedicated traffic using the secondary carrier. In certain implementations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; an CBR associated with primary carrier is lower than a configured threshold CX, where CX is provided by the wireless communication node; or the wireless communication node indicates that a PDCP duplication is active for the dedicated traffic.

In certain implementations, the first wireless communication device can report/provide/transmit to the wireless communication node at least one of the following: an ID of a second wireless communication device; a multi-path request; or Time Sensitive Communications (TSC) assistance information. In certain implementations, the high reliability-related information can be sent to a second wireless communication device over a second RRC message.

In certain implementations, the first wireless communication device can provide/transmit/send the high reliability-related information to the second wireless communication device. In certain implementations, the first wireless communication device can report/provide/transmit to the wireless communication node at least one of the following: an ID of a second wireless communication device; a serving cell ID or network ID corresponding to the second wireless communication device; or TSC assistance information. In certain implementations, prior to the step of reporting, the first wireless communication device can receive/obtain/acquire a capability message from the second wireless communication device. In some implementations, the capability message may include at least one of the following: whether to support muti-path sidelink communication; whether to support L2 muti-path sidelink communication; whether to support L3 muti-path sidelink communication; or whether to support NAS muti-path sidelink communication.

In certain implementations, the first wireless communication device can report to the wireless communication node at least one of the following: an ID of a second wireless communication device; a multi-path request; capability information of the first wireless communication device; capability information of the second wireless communication device; or TSC assistance information. In certain implementations, the TSC assistance information may include at least one of the following: a periodicity; or a Burst Arrival Time and Survival Time for each flow and/or for each destination ID. In some implementations, the capability message may include at least one of the following: whether to support muti-path sidelink communication; whether to support L2 muti-path sidelink communication; whether to support L3 muti-path sidelink communication; or whether to support NAS muti-path sidelink communication.

In certain implementations, in response to receiving the indication information indicating that the multi-path is allowed, the first wireless communication device can transmit/provide/send dedicated traffic using indicated multiple paths. In certain implementations, in response to receiving the indication information indicating the first destination ID list, the first wireless communication device can transmit dedicated traffic using indicated multiple paths to a second wireless communication device associated with the destination ID belonging to the first destination ID list.

In certain implementations, in response to receiving the indication information indicating the primary path is a Uu path, the first wireless communication device can transmit dedicated traffic using the indicated Uu path. In some implementations, in response to the condition being satisfied, the first wireless communication device can transmit the dedicated traffic using a sidelink path. In certain implementations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; an RSRP associated with the Uu path is lower than a configured threshold C2, where C2 is provided by the wireless communication node; the wireless communication node indicates that a PDCP duplication is active for the dedicated traffic; the wireless communication node indicates that the L3 or NAS duplication is active for the dedicated traffic; or the wireless communication node indicates that the secondary path is active for the first wireless communication device.

In certain implementations, in response to receiving the indication information indicating the primary path is a sidelink path, the first wireless communication device can transmit dedicated traffic using the indicated sidelink path. In some implementations, in response to the condition being satisfied, the first wireless communication device can transmit the dedicated traffic using a Uu path. In certain implementations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; a CBR of a current sidelink resource pool or carrier is larger than a configured threshold C3, where C3 is provided by the wireless communication node; the wireless communication node indicates that the secondary path is active for the first wireless communication device; the wireless communication node indicates that a PDCP duplication is active for the dedicated traffic; or the wireless communication node indicates that the L3 or NAS duplication is active for the dedicated traffic.

In certain implementations, each sidelink bearer of the sidelink bearer configuration information can include an indication of whether the termination point is the UE or the network. In certain implementations, the dedicated traffic may include at least one of the following: traffic associated with a destination ID of the second wireless communication device; traffic of a logical channel associated with a DRB configured with survivalTimeStateSupport; traffic of a logical channel associated with a DRB configured with muti-path; or traffic of a logical channel associated with a DRB configured with multi-carriers.

In some implementations, the system of the technical solution disclosed herein can support performing redundant sidelink communication, according to at least one of the following example configurations (e.g., features or solutions):
Example configuration 1: UE Reporting TSC Assistance Information to the Network.
Example configuration 2: First UE Receiving One or More Configurations from the Network.
Example configuration 3: First UE Sending One or More Configurations to Peer UE.
Example configuration 4: UE Triggering Activation of L2/L3/NAS duplication.
Example configuration 5: Second UE Receiving One or More Configurations from the Network.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of V2X sidelink communication, in accordance with some embodiments of the present disclosure;

FIG. 4 illustrates an example implementation of a TSN network, in accordance with some embodiments of the present disclosure;

FIG. 5 illustrates an example implementation of a multi-path relay, in accordance with some embodiments of the present disclosure; and

FIG. 6 illustrates a flow diagram of an example method for performing redundant sidelink communication, in accordance with an embodiment of the present disclosure.

### DETAILED DESCRIPTION

### 1. Mobile Communication Technology and Environment

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

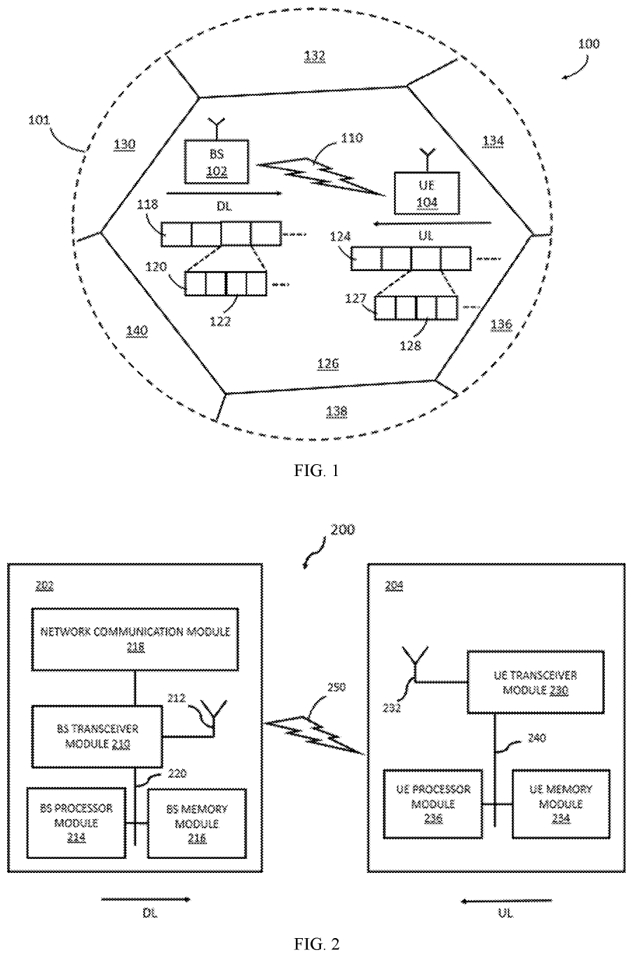

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or multiple microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non-Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Performing Redundant Sidelink Communication

Sidelink is a unilateral wireless communication service, meaning/indicating direct communication between communication terminals. Vehicle networking refers to a large-scale system for wireless communication and information exchange among vehicles, pedestrians, roadside equipment, and/or the internet. The system operates using agreed-upon communication protocols and data exchange standards. Vehicle networking communications enable vehicles to gain/enhance driving safety, improve traffic efficiency, and access convenience or entertainment information. In certain implementations, vehicle networking communication may be categorized into three types as per the objects of wireless communication: vehicle-to-vehicle (V2V) for communication between vehicles; vehicle-to-infrastructure/vehicle-to-network (V2I/V2N) for communication between vehicles and roadside equipment/network infrastructures; and/or vehicle-to-pedestrian (V2P) for communication between vehicles and pedestrians. Collectively, these communication types are referred to as vehicle-to-everything (V2X) communication.

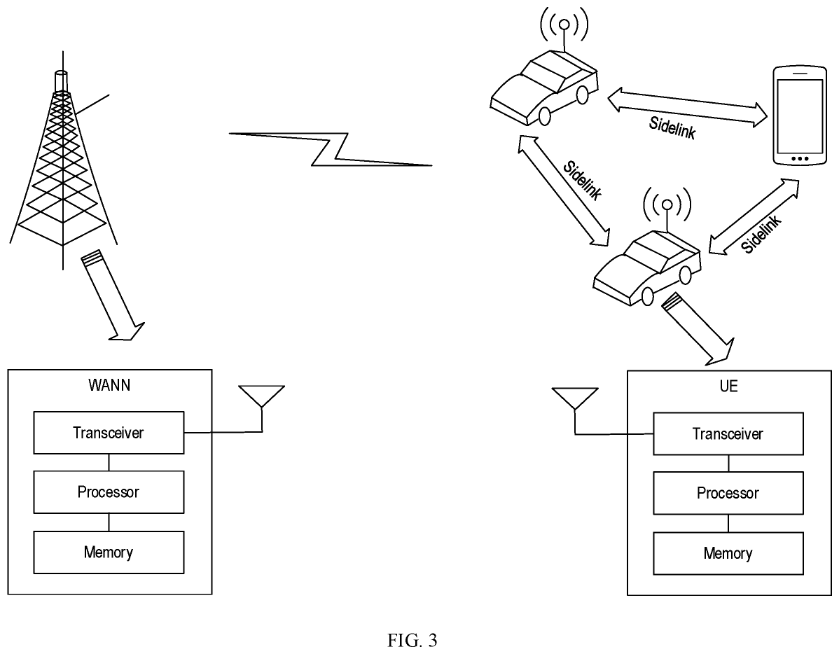

In certain implementations, the sidelink-based V2X communication method between user equipments can be used to implement the V2X standard, in which traffic data can be directly transmitted from a source user equipment to a destination user equipment via an air interface without forwarding by the base station and the core network, as shown in FIG. 3. In some implementations, the V2X communication can be referred to as PC5-based V2X communication or V2X sidelink communication. With the technological advancement and development of the automation industry, the scenarios for V2X communications can be further diversified and require higher performance. The advanced V2X services may include, but are not limited to, vehicle platooning, extended sensors, advanced driving (semi-automated driving and full-automated driving), and/or remote driving. The desired performance requirements may include, but are not limited to, a supporting data packet with a size of 50 to 12000 bytes, a transmission rate of 2 to 50 messages per second, a maximum end-to-end delay of 3 to 500 milliseconds, reliability of 90% to 99.999%, a data rate of 0.5 to 1000 Mbps, and/or a transmission range of 50 to 1000 meters.

In certain implementations, sidelink communication can be used to directly send/transmit user data between devices (via the NR-PC5 interface) instead of routing it via the base station (e.g., gNB), which may require it to pass through the NR-Uu interface twice. In certain implementations, sidelink communication can be used in industrial IoT when devices are in proximity to one another. In certain implementations, user equipment (UEs) of this type, such as mobile robots in the cooperative carrying use case, can maintain a line-of-sight with minimal to no relative motion. For user data transmission between devices, the single wireless hops of sidelink communication (NR-PC5) can provide reduced latency because there is only one wireless hop instead of two via the network.

In certain implementations, such as cooperatively carrying mobile robots, multiple devices can move as a group with limited or no relative mobility among them. In this regard, several implementations/configurations can be considered/expected. For example, in certain implementations, when using sidelink, the quality of communication between devices can be similar. However, in certain implementations, if the devices maintain equal distances from one another as the group of UEs moves across the factory floor, radio conditions and interference can vary. Additionally, in certain implementations, direct data communication may require no handovers.

In certain implementations, depending on the actual location of the devices and/or the corresponding infrastructure elements, better-quality wireless links may be available for sidelink. For example, this can be possible in situations in which sidelink communication between devices is in close proximity to one another, as compared to communicating via the network with fairly distant base stations. For industrial solutions, sidelink can increase reliability by providing an additional transmission path. In certain implementations, both a device-to-network connection (NR-Uu) and a sidelink connection (NR-PC5) can be available to increase/enhance redundancy. For example, in the motion control use case, the failure of one communication path can be compensated for by switching to other/another communication path. In certain implementations, this approach/method may not be standardized and may require a solution involving dual-modem devices above the radio layers. In certain implementations, sidelink communication may not be able to support Time Sensitive Communications (TSC) and Time Sensitive Networking (TSN), resulting in the inability to support deterministic communication for sidelink.

In certain implementations, to communicate TSN type traffic, ensuring deterministic and low-latency SIDELINK transmission may be important. In some implementations, as a UE is communicated via sidelink, the reliability performance of TSN traffic may not meet/satisfy the requirement(s) of the TSN traffic. In certain implementation, as described herein, a UE can perform redundant communication to improve reliability performance for TSN type traffic.

In certain TSN use cases, such as those in a future factory environment, one or more UEs are to handle a mixture/configuration of several different types of traffic. This may include, but is not limited to, multiple periodic streams with different periodicities and/or critical priorities, such as multiple TSN streams coming from different applications. Additionally, there can be an aperiodic critical priority traffic resulting from critical events, such as alarms or safety detectors that are to be informed about the occurrence of a critical event. Furthermore, there can be a best effort type of traffic, such as eMBB traffic, internet traffic, or any other traffic supporting factory operations.

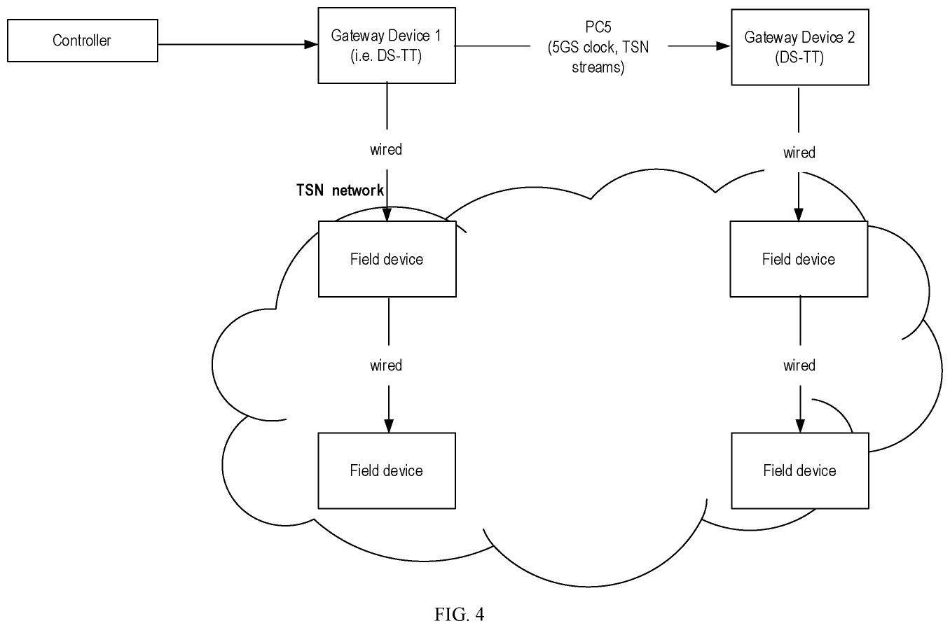

In certain embodiments, as shown in FIG. 4, the TSN system/controller can be located behind a gateway device that supports a DS-TT function and can communicate with field devices located behind a second gateway device that supports a DS-TT function. In some implementations, sidelink communication between the gateway devices may be preferred to reduce the communication latency.

In certain implementations, the DS-TT function can be located in a UE, and the UE can connect to the TSN controller. The TSN controller can collect the TSN stream requirements from end stations. The TSN entity, such as TSN AF, may be responsible for the conversion between TSN traffic characteristics, TSN QoS requirements, and/or the TSN QoS profile. The knowledge of TSC traffic pattern(s) can be used for more efficient scheduling of QoS flows that have periodic, deterministic traffic characteristics. In certain implementations, the TSN controller or other TSN entity can determine and provide TSC Assistance Information (TSCAI) to the UE based on TSC flow traffic characteristics. TSC Assistance Information (TSCAI) may include the periodicity, burst arrival time, and/or survival time.

In certain implementations, a survival time, indicating the time/time period an application can survive without any data burst, may be provided by TSN AF/AF in terms of the maximum number of messages (message is equivalent to all packets of a data burst) or in time units. In some implementations, a single data burst can be expected within a single time period, referred to as the periodicity.

In certain embodiments, the AS layer of a UE can acquire TSC Assistance Information from the NAS layer of the UE. In certain embodiments, a UE can acquire the TSC Assistance Information from the TSC AF or TSC controller. The TSC Assistance Information (TSCAI) may include a periodicity, a burst arrival time, and/or a survival time. In certain implementations, after the UE acquires the TSC Assistance Information, the UE can use the information for resource selection.

In certain embodiments, after a UE acquires the TSC Assistance Information, the UE can use the information to decide whether and when to activate/active PDCP duplication. In certain implementations, a UE can report the TSC Assistance Information (TSCAI), including, but not limited to, a periodicity, a burst arrival time, and/or a survival time for each flow and/or destination ID to the network.

In certain implementations, a UE can receive a configuration for each CG (configured grant) and/or a corresponding logical channel, for example, the configuration indicating that a QoS flow (such as a TSN flow) is mapped to the logical channel/CG. For another example, the configuration indicating the carrier list for each logical channel associated with TSC flow. In certain implementations, a UE can receive one or several configurations. For example, for each DRB, the UE can receive mapping and duplication indications for one or more QoS flows (such as TSN flows). In the case of CA, the UE may receive an indicated allowed carrier list. In some implementations, for example, for each DRB, the UE can receive indication of whether the termination point is the UE or the network. In some implementations, for example, the configurations involving multi-path communication may indicate whether the termination point is the UE or the network, for example, the configurations may indicate whether the termination point is the UE or the network for each destination ID. For another example, the configurations may indicate the destination ID list that termination point is the UE or the destination ID list that termination point is the network. In some implementations, for example, the configurations involving multi-path communication may indicate whether the primary path is via Uu or PC5, and/or indicate whether the termination occurs at the L2 layer, L3 layer, or NAS layer. Additionally, the configurations related to duplication may indicate whether support for survivalTimeState is enabled/provided. In certain implementations, the UE can send/transmit the sidelink bearer configuration to the peer UE, indicating, for example, the carrier list for each logical channel associated with TSC flow.

In certain implementations, for managing SL DRBs (Sidelink Data Radio Bearers) for TSN flows, various implementations/configurations can be considered. For example, in certain implementations/configurations, the SL DRB carrying the TSN flow can activate duplication through RRC configuration. In certain implementations/configurations, the network can configure the SL DRB with one or more of the names/fields/labels/parameters, including the “survivalTimeStateSupport” set to ENUMERATED {true}. In certain implementations, the survivalTimeStateSupport indicates whether the DRB associated with the PDCP entity has survival time state support. If this field is configured to be true, all associated RLC entities can be activated for PDCP duplication upon reception of a retransmission grant addressed to CS-RNTI.

In certain implementations, a UE can trigger/initiate the activation of PDCP duplication for all configured RLC entities of the sidelink DRB when any of the following conditions/implementations are met/satisfied. For example, in some implementations, the activation can be initiated upon reception of a retransmission grant addressed to CS-RNTI from the network based on the retransmission grant used for the MAC PDU that includes the sidelink DRB configured with survivalTimeStateSupport. In some implementations, the activation can be initiated upon reception of one or more NACK feedbacks for the transport block (TB) that includes the sidelink DRB from the peer UE based on the action configured by the network and/or the parameter “N” provided.

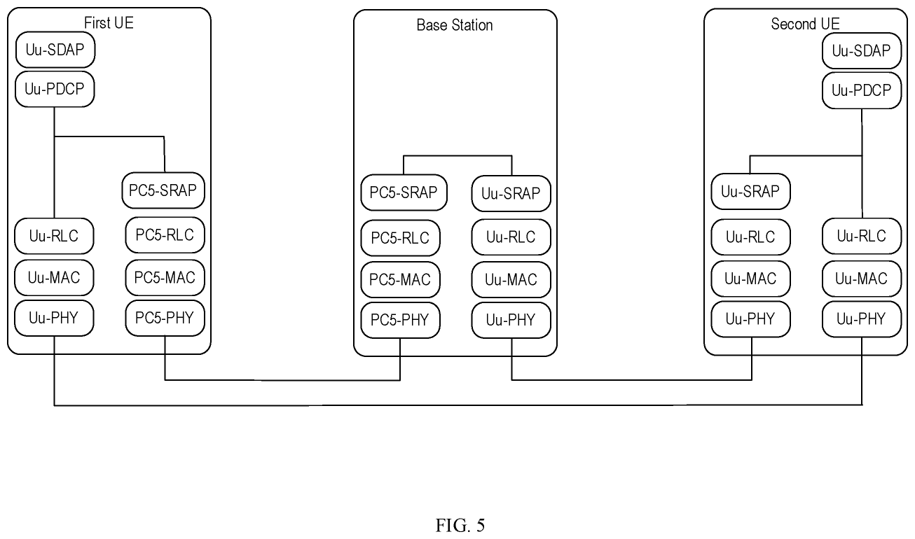

In certain implementations, as shown in FIG. 5, a first UE can connect to a second UE via a direct path or an indirect path. In some implementations, for the direct path, the first UE can communicate with the second UE via the PC5 interface (also referred to as the PC5 path). In some implementations, for the indirect path, the first UE can communicate with the second UE via one or more hops. In certain implementations, one hop can be between the first UE and the serving cell of the first UE, and another hop can be between the serving cell of the second UE and the second UE. In certain implementations, the serving cell of the first UE and/or the serving cell of the second UE may belong to or be connected to the same network node, such as a base station or a control unit (also referred to as the Uu path).

In certain embodiments, where the UE and/or network support the multi-path function and the UE utilizes multi-path to send dedicated traffic, the UE can send the request to the network. Upon receiving the request, the network can determine whether or how to use the multi-path. In certain implementations/embodiments, for example, in a first UE configuration, the first UE can perform data transmission and reception using the Uu path. In certain implementations, where a first UE is connected to a second UE using a PC5 link, the first UE can report at least one of the following information to the network node: the ID of the second UE, such as a destination ID or C-RNTI; a multi-path request, which may additionally specify/indicate an L2 multi-path request or an L3 multi-path request; and/or TSN assistant information. In some implementations, the TSN assistant information may include details, including, but not limited to, periodicity, burst arrival time, and/or survival time. In certain implementations, the network node can decide/determine whether to configure one or more than one path for the first UE. The cell serving the first UE and/or the cell serving the second UE may belong to the same network node but can be the same or different.

In certain implementations, the network node can send/transmit a first RRC message to the first UE. In some implementations, the first RRC message may include at least one of the following: an indication that multiple paths are used for the first UE, sidelink bearer configuration information, and/or multipath configuration information.

In certain implementations, each sidelink bearer configuration can be associated with at least one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. Additionally, each sidelink bearer configuration may include a first PDCP duplication indication, which may indicate the primary path or may indicate whether the Uu path or the sidelink path is the primary path.

In certain impetrations, each sidelink bearer configuration may include a second PDCP duplication indication to indicate/determine whether the PDCP duplication is active under specific conditions or in certain implementations. The conditions/implementation may include: the UE being in a survival state for the sidelink bearer; the UE receiving a NACK or no feedback for the TB that includes the sidelink bearer from the peer UE; the UE receiving N NACK or no feedback for the TB that includes the sidelink bearer from the peer UE, with the parameter/number N provided by the network; the UE receiving a NACK or no feedback for the TB that includes any sidelink bearer configured with the second PDCP duplication indication from the peer UE; the UE receiving N NACK or no feedback for the TB that includes any sidelink bearer configured with the second PDCP duplication indication from the peer UE, with the parameter/number N provided by the network; and/or the CBR of current resource pool or carrier being larger than the configured threshold C1, with the value C1 provided by the network. In certain implementations, the UE can active/activate the PDCP duplication for the sidelink bearer when any of the above conditions/implementations are satisfied.

In certain implementations, the multipath configuration information may include at least one of the following: a list of bearer IDs that utilize multi-path (such as Uu path and/or SL path) for transmission; a first ID or index representing the first UE for the Uu path in the communication between the first UE and second UE; a second ID or index representing the second UE for the Uu path in the communication between the first UE and second UE; a third ID or index representing the first UE for the PC5 path in the communication between the first UE and second UE; a fourth ID or index representing the second UE for the PC5 path in the communication between the first UE and second UE; and/or a pair/combination of source ID and/or destination ID used to identify the communication between the first UE and second UE.

In certain implementations, the first UE can send/transmit the data via the Uu RLC channel and/or one sidelink RLC channel. In some implementations, where the network receives the data of/from the Uu RLC channel, the network can determine that the data is associated with the second UE based on the second ID or index carried in/within the data packet. In some implementations, the network can forward the data to the second UE.

In certain embodiments/implementations, where the network node knows/determines that the cell serving the first UE and/or the cell serving the second UE belong to the same network node, which can be the same or different, the network node can decide/determine to configure one or more than one path for the first UE. In certain embodiments, the network node can send/transmit a second RRC message to the second UE. In certain implementations, the second RRC message may include: an indication indicating multiple paths used for the first UE; sidelink bearer configuration information; and/or multipath configuration information. In some implementations, each sidelink bearer configuration can be associated with at least one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. In some implementations, each sidelink bearer configuration may include a first PDCP duplication indication, which may indicate the primary path or may indicate whether the Uu path or the sidelink path is the primary path.

In certain implementations, the multipath configuration information may include at least one of the following: a list of bearer IDs that utilize multi-path (such as Uu path and SL path) for transmission; a first ID or index representing the first UE for the Uu path in the communication between the first UE and second UE; a second ID or index representing the second UE for the Uu path in the communication between the first UE and second UE; a third ID or index representing the first UE for the PC5 path in the communication between the first UE and second UE; a fourth ID or index representing the second UE for the PC5 path in the communication between the first UE and second UE; and/or a pair/combination of source ID and/or destination ID used to identify the communication between the first UE and second UE.

In certain embodiments, after acquiring/obtaining/receiving the configuration information from the network, the first UE can send/transmit the information to the second UE. In certain implementations, the first UE can send/transmit the sidelink bearer configuration information to the second UE. In some implementations, each sidelink bearer configuration can be associated with one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. In some implementations, each sidelink bearer configuration may include a first PDCP duplication indication, which may indicate the primary path or whether the Uu path or the sidelink path is the primary path.

In certain implementations, the first UE can send/transmit the multipath configuration information to the second UE. In some implementations, the multipath configuration information may include at least one of the following: a list of bearer IDs that use multi-path (such as Uu path and/or SL path) for transmission; the first ID or index representing the first UE for the Uu path in the communication between the first UE and second UE; and/or the second ID or index representing the second UE for the Uu path in the communication between the first UE and second UE.

In certain implementations, the first UE can send/transmit the data via the Uu RLC channel and/or one sidelink RLC channel. In some implementations, where the network receives the data of/from the Uu RLC channel, the network can determine that the data is associated with the second UE based on the second ID or index carried in the data packet. In certain implementations, the network can forward the data to the second UE.

In certain embodiments, where the UE and/or network support the multi-path function, the UE can report/provide information about the peer UE, such as the destination ID, C-RNTI, serving cell ID, or network node ID of peer UE to the network. In certain implementations, upon receiving the information, the network node can determine whether to configure multi-path for the UE.

In certain embodiments/implementations, where the UE is or may be connected with the second UE using the PC5 link, the first UE can report at least one of the following information to the network node: an ID of the second UE, such as destination ID or C-RNTI; a serving cell ID or a network node ID of the second UE; and/or TSN assistant information. In certain implementations, the TSN assistant information may include details, including, but not limited to, periodicity, burst arrival time, and/or survival time. In certain implementations, before reporting/providing the aforementioned information to the network node, the first UE can receive a capability message from the second UE. In some implementations, the capability message may include at least one of the following: whether the second UE supports multi-path sidelink communication; whether the second UE supports L2 multi-path sidelink communication; or whether the second UE supports L3 multi-path sidelink communication.

In certain implementations, the network node can decide/determine whether to configure one or more than one path for the first UE. In some implementations, the cell serving the first UE and/or the cell serving the second UE can belong to the same network node but can be the same or different. In certain implementations, the network node can send/transmit a first RRC message to the first UE. In some implementations, the first RRC message may include at least one of the following: an indication indicating that multiple paths are used for the first UE; sidelink bearer configuration information; and/or multipath configuration information.

In certain implementations, each sidelink bearer configuration can be associated with at least one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. In some implementations, each sidelink bearer configuration may include a first PDCP duplication indication, which may indicate the primary path or whether the Uu path or the sidelink path is the primary path.

In some implementations, each sidelink bearer configuration may include a second PDCP duplication indication to indicate/determine whether the PDCP duplication is active under/for specific conditions or in certain implementations. The conditions/implementations may include: the UE being in survival state for the sidelink bearer; the UE receiving a NACK or no feedback for the TB that includes the sidelink bearer from the peer UE; the UE receiving N NACK or no feedback for the TB that includes the sidelink bearer from the peer UE, with the parameter/number N provided by the network; the UE receiving a NACK or no feedback for the TB that includes any sidelink bearer configured with the second PDCP duplication indication from the peer UE; the UE receiving N NACK or no feedback for the TB that includes any sidelink bearer configured with the second PDCP duplication indication from the peer UE, with the parameter/number N provided by the network; and/or the CBR of current resource pool or carrier being larger than the configured threshold C1, with the value C1 provided by the network. In certain implementations, the UE can active/activate the PDCP duplication for the sidelink bearer when any of the aforementioned conditions/implementations are satisfied.

In certain implementations, the multipath configuration information may include at least one of the following: a list of bearer IDs that utilize multi-path (such as the Uu path and/or SL path) for transmission; a first ID or index representing the first UE for the Uu path in the communication between the first UE and second UE; a second ID or index representing the second UE for the Uu path in the communication between the first UE and second UE; a third ID or index representing the first UE for the PC5 path in the communication between the first UE and second UE; a fourth ID or index representing the second UE for the PC5 path in the communication between the first UE and second UE; and/or a pair/combination of source ID and/or destination ID used to identify the communication between the first UE and second UE.

In certain implementations, the first UE can send/transmit the data via the Uu RLC channel and/or one sidelink RLC channel. In some implementations, where the network receives the data of/from the Uu RLC channel, the network can determine that the data is associated with the second UE based on the second ID or index carried in/within the data packet. In some implementations, the network can forward/transmit/send the data to the second UE.

In certain embodiments/configurations, where the network node knows/determines that the cell serving the first UE and/or the cell serving the second UE can belong to the same network node but can be the same or different, the network can decide/determine whether to configure one or more than one path for the first UE. In certain embodiments, the network node can send/transmit a second RRC message to the second UE. In certain implementations, the second RRC message may include at least one of the following: an indication indicating that multiple paths are used for the first UE; sidelink bearer configuration information; and/or multipath configuration information.

In certain implementations, each sidelink bearer configuration can be associated with one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. In some implementations, each sidelink bearer configuration may include a first PDCP duplication indication, which may indicate the primary path or whether the Uu path or the sidelink path is the primary path.

In certain implementations, the multipath configuration information may include at least one of the following: a list of bearer IDs that utilize multi-path (such as the Uu path and/or SL path) for transmission; a first ID or index representing the first UE for the Uu path in the communication between the first UE and second UE; a second ID or index representing the second UE for the Uu path in the communication between the first UE and second UE; a third ID or index representing the first UE for the PC5 path in the communication between the first UE and second UE; a fourth ID or index representing the second UE for the PC5 path in the communication between the first UE and second UE; and/or a pair/combination of source ID and/or destination ID used to identify the communication between the first UE and second UE.

In certain embodiments, after acquiring/receiving/obtaining the configuration information from the network, the first UE can send/transmit the information to the second UE. In certain implementations, the first UE can send/transmit the sidelink bearer configuration information to the second UE. In some implementations, each sidelink bearer configuration can be associated with at least one Uu RLC channel and/or one sidelink RLC channel. In some implementations, the Uu RLC channel configuration can correspond to a first logical channel between the first UE and network. In some implementations, the sidelink RLC channel configuration can correspond to a second logical channel between the first UE and the second UE. In some implementations, each sidelink bearer configuration may include a first PDCP duplication indication, which may indicate the primary path or whether the Uu path or the sidelink path is the primary path.

In certain implementations, the first UE can send/transmit the multipath configuration information to the second UE. In some implementations, the multipath configuration information may include at least one of the following: a list of bearer IDs that utilize multi-path (such as the Uu path and/or SL path) for transmission; the first ID or index representing the first UE for the Uu path in the communication between the first UE and second UE; or the second ID or index representing the second UE for the Uu path in the communication between the first UE and second UE.

In certain implementations, the first UE can send/transmit the data via the Uu RLC channel and/or one sidelink RLC channel. In some implementations, where the network receives the data of/from the Uu RLC channel, the network can determine that the data is associated with the second UE based on the second ID or index carried in/within the data packet. In some implementations, the network can forward/send the data to the second UE.

In certain embodiments, where a UE has established a PC5 link with a second UE to improve the reliability of traffic between UEs, the UE can transmit the same traffic to the peer UE via the Uu link and/or the sidelink. However, this approach/implementation may require more radio resources for communication, and one or both UEs are to support the L3/NAS duplication function.

In certain embodiments/implementations, where the first UE is or may be connected to the second UE using the PC5 link, the first UE can report/provide at least one of the following information to the network node: an ID of the second UE for sidelink communication, such as destination ID or C-RNTI; a multi-path request, which may further indicate an L2 multi-path request or an L3/NAS multi-path request; or TSN assistant information, where the TSN assistant information may include periodicity, burst arrival time, and/or survival time; and/or capability information of the first UE, indicating its support for L2 multi-path or L3/NAS multi-path. In some implementations, before reporting the capability information of the second UE, the UE can receive the capability information of the second UE from the second UE via PC5.

In certain implementations, where the network node allows/enables the first UE using L2 multi-path or L3/NAS multi-path to transmit dedicated traffic, the network can send the indication to the first UE. In some implementations, the indication may include at least one of the following: whether L3/NAS multi-path is allowed; whether L2 multi-path is allowed; a list of destination IDs for which L3/NAS multi-path is allowed; a list of destination IDs for which L2 multi-path is allowed; which path is the primary path; and/or the conditions under which the secondary path can be used.

In certain implementations, where the UE receives an indication indicating that the L3/NAS multi-path is allowed, the UE can use the L3/NAS multi-path to transmit dedicated traffic. In some implementations, where a list of destination IDs is provided, the UE can use the L3/NAS multi-path to transmit dedicated traffic associated with the destination ID in the list. In some implementations, where the UE receives an indication indicating that the L2 multi-path is allowed, the UE can use the L2 multi-path to transmit dedicated traffic. In some implementations, where a list of destination IDs is provided, the UE can use the L2 multi-path to transmit dedicated traffic associated with the destination ID in the list. In some implementations, where the UE receives an indication indicating that the primary path is the Uu path, the UE can use the Uu path to transmit dedicated traffic. Additionally, upon satisfying the condition, the UE can use the sidelink path to transmit dedicated traffic. In some implementations, where the UE receives an indication indicating that the primary path is the sidelink path, the UE can use the sidelink path to transmit dedicated traffic. Additionally, upon satisfying the condition, the UE can use the Uu path to transmit dedicated traffic.

In certain implementations, where the primary path is the Uu path, the condition(s) of using a secondary path may include at least one of the following: the UE receiving a NACK or no feedback for the TB that includes the dedicated traffic; the UE receiving N NACK or no feedback for the TB that includes the dedicated traffic, with the parameter/number N provided by the network; the RSRP associated with the Uu path being lower than the configured threshold C2, with the value C2 provided by the network; and/or the network indicating that the secondary path is active for dedicated traffic.

In certain implementations, where the primary path is the sidelink path, the condition(s) of using a secondary path may include at least one of the following: the UE receiving a NACK or no feedback for the TB that includes the dedicated traffic; the UE receiving N NACK or no feedback for the TB that includes the dedicated traffic, with the parameter/number N provided by the network; the CBR of the current sidelink resource pool or carrier being larger than the configured threshold C3; with the value C3 provided by the network; and/or the network indicating that the secondary path is active for dedicated traffic.

In certain implementations, the dedicated traffic may include at least one of the following: the traffic associated with the destination ID of the second UE; the traffic of the logical channel associated with a DRB configured with survivalTimeStateSupport; and/or the traffic of the logical channel associated with a DRB configured with multi-path. In certain implementations, the first UE can send/transmit the data via the Uu path and/or one sidelink path.

In certain embodiment/implementations, where the network node allows/enables the first UE to use the L2 multi-path or L3/NAS multi-path for transmitting dedicated traffic to the second UE, the network node can send an indication to the first UE. In some implementations, the network node may send an indication to the second UE.

In certain implementations, the network node can send/transmit a second RRC message to the second UE. In some implementations, the second RRC message may include at least one of the following: a list of source/destination IDs for which L3/NAS multi-path is allowed; a list of source/destination IDs for which L2 multi-path is allowed; and/or an indication of which path is the primary path.

In certain implementations, where the UE receives the indication of the list of source/destination IDs for which L3/NAS multi-path is allowed/enabled, the UE can receive dedicated traffic associated with the source/destination IDs in the list via L3/NAS multi-path. In certain implementations, where the UE receives the indication of the list of source/destination IDs for which L2 multi-path is allowed/enabled, the UE can receive the dedicated traffic associated with the source/destination IDs in the list via L2 multi-path.

In certain embodiments, where the first UE acquires/receives/obtains the configuration information from the network, the first UE can send the information to the second UE. In some implementations, the first UE can send/transmit at least one of the following information to the second UE: whether L3/NAS multi-path is allowed; whether L2 multi-path is allowed; and/or which path is the primary path. In certain implementations, the second UE can receive dedicated traffic from the first UE via both the sidelink path and the Uu path.

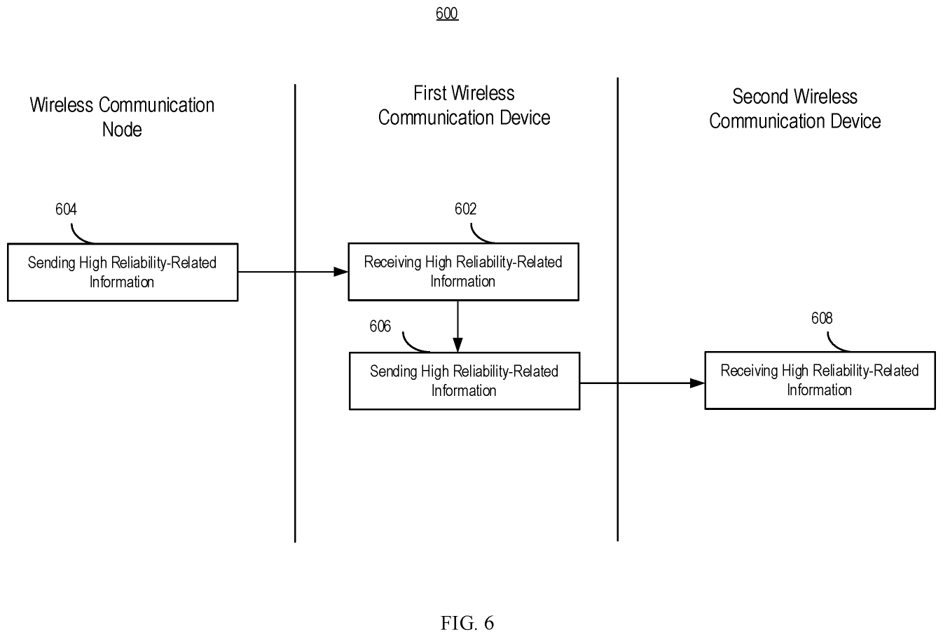

Referring now to FIG. 6, which illustrates a flow diagram of a method 600 for performing redundant sidelink communication. The method 600 may be implemented using any of the components and devices detailed herein in conjunction with FIGS. 1-5. In an overview, the method 600 may include a first wireless communication device receiving/obtaining/acquiring high reliability-related information from a wireless communication node (STEP 602). The method may include the wireless communication node sending/transmitting/providing the high reliability-related information to the first wireless communication device (STEP 604). The method may include the first wireless communication device sending the high reliability-related information to a second wireless communication device (STEP 606). The method may include the second wireless communication device receiving the high reliability-related information from the first wireless communication device (608).

In certain configurations, a first wireless communication device (e.g., user equipment) can receive/obtain/acquire high reliability-related information from a wireless communication node (e.g., base station) (STEP 602). In certain implementations, the wireless communication node can send/transmit/provide the high reliability-related information to the first wireless communication device (STEP 604). In certain configurations, the high reliability-related information may include at least one of the following: information indicating multi-path communication is configured for the first wireless communication device; sidelink bearer configuration information; muti-path configuration information; or sidelink carrier configuration information. In certain configurations, the high reliability-related information can be sent to the first wireless communication device over a first Radio Resource Control (RRC) message.

In certain configurations, each sidelink bearer of the sidelink bearer configuration information can be associated with at least one of a Uu Radio Link Control (RLC) Channel or a sidelink RLC Channel. In certain configurations, each sidelink bearer of the sidelink bearer configuration information can be associated with multiple carriers. In certain implementations, the Uu RLC Channel can correspond to a first logical channel between the first wireless communication device and the wireless communication node. In certain configurations, the sidelink RLC channel can correspond to a second logical channel between the first wireless communication device and a second wireless communication device. In some implementations, the first and second wireless communication devices can communicate with each other through a PC5 interface.

In certain configurations, each sidelink bearer of the sidelink bearer configuration information may include a first Packet Data Convergence Protocol (PDCP) configuration indication. In some implementations, the first PDCP configuration indication can indicate a primary path as a Uu path or a sidelink path. In certain configurations, each sidelink bearer of the sidelink bearer configuration information may include a second PDCP configuration indication. In some implementations, the second PDCP configuration indication can indicate whether PDCP duplication can be activated in response to satisfying at least one of the following conditions: the first wireless communication device is in a survival state for a sidelink bearer; the first wireless communication device receives a NACK message or no feedback message for a transport block that includes the associated sidelink bearer from the second wireless communication device; the first wireless communication device receives N NACK messages or no feedback message for a transport block that includes the associated sidelink bearer from the second wireless communication device, where N is provided by the wireless communication node; the first wireless communication device receives a NACK message or no feedback message for a transport block that includes at least one sidelink bearer configured with the second PDCP configuration indication from the second wireless communication device; the first wireless communication device receives N NACK messages or no feedback message for a transport block that includes at least one sidelink bearer configured with the second PDCP configuration indication from the second wireless communication device, where N is provided by the wireless communication node; or a Channel Busy Ratio (CBR) of a current resource pool or carrier is larger than a configured threshold C1, where C1 is provided by the wireless communication node.

In certain configurations, the muti-path configuration information may include at least one of the following: a bearer ID list configuring multiple paths to transmit; a first ID or index of the first wireless communication device for a Uu path associated to the communication between the first wireless communication device and a second wireless communication device; a second ID or index of the second wireless communication device for the Uu path associated to the communication between the first wireless communication device and the second wireless communication device; a third ID or index of the first wireless communication device for a PC5 path between the first wireless communication device and the second wireless communication device; a fourth ID or index of the second wireless communication device for the PC5 path between the first wireless communication device and the second wireless communication device; a pair of a source ID and a destination ID that can be used to identify communication between the first wireless communication device and the second wireless communication device; or an indication of whether the termination point is the UE or the network.

In certain configurations, the muti-path configuration may include at least one of the following: whether L2 muti-path sidelink communication is configured; whether L3 muti-path sidelink communication is configured; whether NAS muti-path sidelink communication is configured; a source or destination ID list indicating which L3 multi-path is allowed; a source or destination ID list indicating which NAS multi-path is allowed; a source or destination ID list indicating which L2 multi-path is allowed; a pair of source and destination ID list indicating which L2 multi-path is allowed; a pair of source and destination ID list indicating which L3 multi-path is allowed; a pair of source and destination ID list indicating which NAS multi-path is allowed; an indication of a primary path; or a condition of using a secondary path.

In certain configurations, the sidelink carrier configuration information can indicate a primary carrier or a secondary carrier. In certain configurations, in response to receiving the sidelink carrier configuration information indicating the primary carrier or the secondary carrier, the first wireless communication device can transmit dedicated traffic using the primary carrier. In some implementations, in response to the condition being satisfied, the first wireless communication device can transmit the dedicated traffic using the secondary carrier. In certain configurations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; an CBR associated with primary carrier is lower than a configured threshold CX, where CX is provided by the wireless communication node; or the wireless communication node indicates that a PDCP duplication is active for the dedicated traffic.

In certain configurations, the first wireless communication device can report/provide/transmit to the wireless communication node at least one of the following: an ID of a second wireless communication device; a multi-path request; or Time Sensitive Communications (TSC) assistance information. In certain configurations, the high reliability-related information can be sent to a second wireless communication device over a second RRC message.

In certain configurations, the first wireless communication device can provide/transmit/send the high reliability-related information to the second wireless communication device (STEP 606). In certain configurations, the first wireless communication device can report/provide/transmit to the wireless communication node at least one of the following: an ID of a second wireless communication device; a serving cell ID or network ID corresponding to the second wireless communication device; or TSC assistance information. In certain configurations, prior to the step of reporting, the first wireless communication device can receive/obtain/acquire a capability message from the second wireless communication device. In some implementations, the capability message may include at least one of the following: whether to support muti-path sidelink communication; whether to support L2 muti-path sidelink communication; whether to support L3 muti-path sidelink communication; or whether to support NAS muti-path sidelink communication.

In certain configurations, the first wireless communication device can report to the wireless communication node at least one of the following: an ID of a second wireless communication device; a multi-path request; capability information of the first wireless communication device; capability information of the second wireless communication device; or TSC assistance information. In certain configurations, the TSC assistance information may include at least one of the following: a periodicity; or a Burst Arrival Time and Survival Time for each flow and/or for each destination ID.

In certain configurations, in response to receiving the indication information indicating that the multi-path is allowed, the first wireless communication device can transmit/provide/send dedicated traffic using indicated multiple paths. In certain configurations, in response to receiving the indication information indicating the first destination ID list, the first wireless communication device can transmit dedicated traffic using indicated multiple paths to a second wireless communication device associated with the destination ID belonging to the first destination ID list.

In certain configurations, in response to receiving the indication information indicating the primary path is a Uu path, the first wireless communication device can transmit dedicated traffic using the indicated Uu path. In some implementations, in response to the condition being satisfied, the first wireless communication device can transmit the dedicated traffic using a sidelink path. In certain configurations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; an RSRP associated with the Uu path is lower than a configured threshold C2, where C2 is provided by the wireless communication node; the wireless communication node indicates that a PDCP duplication is active for the dedicated traffic; the wireless communication node indicates that the L3 or NAS duplication is active for the dedicated traffic; or the wireless communication node indicates that the secondary path is active for the first wireless communication device.

In certain configurations, in response to receiving the indication information indicating the primary path is a sidelink path, the first wireless communication device can transmit dedicated traffic using the indicated sidelink path. In some implementations, in response to the condition being satisfied, the first wireless communication device can transmit the dedicated traffic using a Uu path. In certain configurations, the condition may include at least one of the following: the first wireless communication device receives a NACK message or no feedback message for a transport block that includes the dedicated traffic; the first wireless communication device receives N NACK messages or no feedback message for a transport block that includes the dedicated traffic, where N is provided by the wireless communication node; a CBR of a current sidelink resource pool or carrier is larger than a configured threshold C3, where C3 is provided by the wireless communication node; the wireless communication node indicates that the secondary path is active for the first wireless communication device; the wireless communication node indicates that a PDCP duplication is active for the dedicated traffic; or the wireless communication node indicates that the L3 or NAS duplication is active for the dedicated traffic.

In certain configurations, each sidelink bearer of the sidelink bearer configuration information can include an indication of whether the termination point is the UE or the network. In certain configurations, the dedicated traffic may include at least one of the following: traffic associated with a destination ID of the second wireless communication device; traffic of a logical channel associated with a DRB configured with survivalTimeStateSupport; traffic of a logical channel associated with a DRB configured with muti-path; or traffic of a logical channel associated with a DRB configured with multi-carriers.

At least one aspect is directed to a system, method, apparatus, or a computer-readable medium. In certain configurations, the second wireless communication device can receive the high reliability-related information from the first wireless communication device (STEP 608).

While various embodiments/implementations of the present solution have been described above, it should be understood that they have been presented by way of example only, and not by way of limitation. Likewise, the various diagrams may depict an example architecture or configuration, which are provided to enable persons of ordinary skill in the art to understand example features and functions of the present solution. Such persons would understand, however, that the solution is not restricted to the illustrated example architectures or configurations but can be implemented using a variety of alternative architectures and configurations. Additionally, as would be understood by persons of ordinary skill in the art, one or multiple features of one embodiment/implementation can be combined with one or multiple features of another embodiment/implementation described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits, and symbols, which may be referenced in the above description, can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components, and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or multiple microprocessors in conjunction with a DSP core, or any other suitable configuration to perform the functions described herein.

If implemented in software, the functions can be stored as one or multiple instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein but is to be accorded the widest scope consistent with the novel features and principles disclosed herein, as recited in the claims below.

1. A wireless communication method, comprising:
receiving, by a first wireless communication device from a wireless communication node, high reliability-related information in a radio resource control (RRC) message.
wherein the high reliability-related information comprises: multi-path configuration information, and information indicating multi-path communication is configured for the first wireless communication device.

2. The wireless communication method of claim 1, wherein the high reliability-related information further comprises a first Packet Data Convergence Protocol (PDCP) configuration indication, and wherein the first PDCP configuration indication indicates a primary path as a Uu path or a sidelink path.

3. The wireless communication method of claim 1, wherein the multi-path configuration information comprises at least one of: an identifier (ID) of the first wireless communication device for a PC5 path between the first wireless communication device and a second wireless communication device; or an ID of the second wireless communication device for the PC5 path between the first wireless communication device and the second wireless communication device.

4. The wireless communication method of claim 1, wherein the high reliability-related information includes at least one of: an indication of whether L2 multi-path sidelink communication is configured; an indication of which NAS multi-path is allowed; an indication of a primary path; or a condition of using a secondary path.

5. A first wireless communication device, comprising:
at least one processor and a receiver configured to:
receive, from a wireless communication node, high reliability-related information in a radio resource control (RRC) message,
wherein the high reliability-related information comprises: multi-path configuration information, and information indicating multi-path communication is configured for the first wireless communication device.

6. The first wireless communication device of claim 5, wherein the high reliability-related information further comprises a first Packet Data Convergence Protocol (PDCP) configuration indication, and wherein the first PDCP configuration indication indicates a primary path as a Uu path or a sidelink path.

7. The first wireless communication device of claim 5, wherein the multi-path configuration information comprises at least one of: a third ID or index of the first wireless communication device for a PC5 path between the first wireless communication device and a second wireless communication device; or a fourth ID or index of the second wireless communication device for the PC5 path between the first wireless communication device and the second wireless communication device.

8. The first wireless communication device of claim 5, wherein the high reliability-related information includes at least one of: an indication of whether L2 multi-path sidelink communication is configured; a source ID indicating which NAS multi-path is allowed; an indication of a primary path; or a condition of using a secondary path.

9. A wireless communication method, comprising:
transmitting, by a wireless communication node to a first wireless communication device, high reliability-related information in a radio resource control (RRC) message,
wherein the high reliability-related information comprises: multi-path configuration information, and information indicating multi-path communication is configured for the first wireless communication device.

10. The wireless communication method of claim 9, wherein the high reliability-related information further comprises a first Packet Data Convergence Protocol (PDCP) configuration indication, and wherein the first PDCP configuration indication indicates a primary path as a Uu path or a sidelink path.

11. The wireless communication method of claim 9, wherein the multi-path configuration information comprises at least one of: an identifier (ID) of the first wireless communication device for a PC5 path between the first wireless communication device and a second wireless communication device; or an ID of the second wireless communication device for the PC5 path between the first wireless communication device and the second wireless communication device.

12. The wireless communication method of claim 9, wherein the high reliability-related information includes at least one of: an indication of whether L2 multi-path sidelink communication is configured; an indication of which NAS multi-path is allowed; an indication of a primary path; or a condition of using a secondary path.

13. A wireless communication node, comprising:
at least one processor and a transmitter configured to:
transmit, to a first wireless communication device, high reliability-related information in a radio resource control (RRC) message,
wherein the high reliability-related information comprises: multi-path configuration information, and information indicating multi-path communication is configured for the first wireless communication device.

14. The wireless communication node of claim 13, wherein the high reliability-related information further comprises a first Packet Data Convergence Protocol (PDCP) configuration indication, and wherein the first PDCP configuration indication indicates a primary path as a Uu path or a sidelink path.

15. The wireless communication node of claim 13, wherein the multi-path configuration information comprises at least one of: an identifier (ID) of the first wireless communication device for a PC5 path between the first wireless communication device and a second wireless communication device; or an ID of the second wireless communication device for the PC5 path between the first wireless communication device and the second wireless communication device.

16. The wireless communication node of claim 13, wherein the high reliability-related information includes at least one of: an indication of whether L2 multi-path sidelink communication is configured; an indication of which NAS multi-path is allowed; an indication of a primary path; or a condition of using a secondary path.
